(19) United States
(12) Patent Application Publication
(10) Pub. No.: US 2013/0186375 A1
(43) Pub. Date: Jul. 25, 2013

(54) TRAP CANISTER CAPTURING FUEL VAPOR

(71) Applicant: AISAN KOGYO KABUSHIKI KAISHA, Obu-shi (JP)

(72) Inventors: Masakazu HASEGAWA, Miyoshi (JP); Ryuji KOSUGI, Obu-shi (JP)

(73) Assignee: AISAN KOGYO KABUSHIKI KAISHA, Obu-shi (JP)

(21) Appl. No.: 13/749,115

(22) Filed: Jan. 24, 2013

(30) Foreign Application Priority Data
Jan. 24, 2012 (JP) 2012-012001

(51) Int. Cl. F02M 25/06

(52) U.S. Cl. CPC F02M 25/06
USPC 123/519

(57) ABSTRACT

A trap canister is configured to capture fuel vapor contained in breakthrough gas discharged from an adsorbent canister. The trap canister has a housing defining an adsorption chamber therein, a breathable partition member disposed in the housing and dividing the adsorption chamber into a first chamber and a second chamber, an adsorbent filled in the first chamber and the second chamber, and a latent heal storage material tilled in the first chamber in a mixed manner with the adsorbent. The first chamber is configured to receive breakthrough gas, while the second chamber is configured to communicate with the atmosphere. The first chamber has a cross-sectional area larger than that of the second chamber.

This application claims priority to Japanese patent application serial number 2012-12001, the contents of which are incorporated herein by reference.

### BACKGROUND OF THE INVENTION

This invention relates to a trap canister that is mainly used for vehicle, in particular to a trap canister configured to adsorb fuel vapor contained in breakthrough gas discharged from an adsorbent canister.

A conventional trap canister has a housing having one end communicating with the atmosphere and the other end receiving breakthrough gas from an adsorbent canister. The housing defines therein an adsorption chamber filled with activated carbon, i.e., adsorbent capable of adsorbing and desorbing fuel vapor. Japanese Laid-Open Patent Publication No. 2005-35812 discloses a trap canister defining therein an adsorption chamber having the same cross-sectional area over a path length along a flow direction of breakthrough gas.

When the adsorbent canister (referred to as “main canister”, hereafter) capable of adsorbing fuel vapor discharges breakthrough gas containing fuel vapor, the breakthrough gas is introduced into the trap canister, and the adsorbent housed in the trap canister captures the fuel vapor. Then, the fuel vapor is desorbed (purged) from the adsorbent by using negative pressure caused by admission of an internal combustion engine. If the fuel vapor remains on the adsorbent after such purging operation, fuel component might desorb from the adsorbent and flow to the outside of the vehicle during parking. In particular, activated carbon used as the adsorbent has a wide distribution range of pore diameter. A pore with a smaller opening has higher adsorptive property than a pore with a larger opening. Thus, when fuel vapor is captured in the pore with the smaller opening, the fuel vapor is hard to desorb during the purging operation. When the amount of the fuel vapor remaining in the pore with the smaller opening increases, the amount of the fuel vapor flowing into the atmosphere during parking increases. In order to decrease the amount of the fuel vapor flowing into the atmosphere, it has been known to increase the L/D ratio with respect to length L of the adsorption chamber and diameter D relating to cross-sectional area of the adsorption chamber. Increase in the L/D ratio improves adsorption and desorption ability and makes pressure loss higher. Thus, it has been difficult to decrease the amount of the fuel vapor flowing into the atmosphere from the trap canister while decreasing pressure loss. Therefore, there has been need for improved trap canisters.

### BRIEF SUMMARY OF THE INVENTION

In one aspect of this disclosure, a trap canister is configured to capture fuel vapor contained in breakthrough gas discharged from an adsorbent canister. The trap canister has a housing defining an adsorption chamber therein, a breathable partition member disposed in the housing and dividing the adsorption chamber into a first chamber and a second chamber, an adsorbent filled in the first chamber and the second chamber, and a latent heat storage material filled in the first chamber in a mixed manner with the adsorbent. The first chamber is configured to receive breakthrough gas, while the second chamber is configured to communicate with the atmosphere. The first chamber has cross-sectional area larger than that of the second chamber.

According to this aspect, since the cross-sectional area of the first chamber is larger than that of the second chamber, adsorption and desorption ability of the adsorbent, in the second chamber having the smaller cross-sectional area is improved. In addition, the first chamber having the larger cross-sectional area can absorb increase in pressure loss caused by the second chamber, so that it is able to prevent increase in pressure loss, to decrease the amount of fuel vapor remaining in the trap canister, and to decrease the amount of fuel vapor passing through the trap canister. Further, since the latent heat storage material is filled in the first chamber in the mixed manner with the adsorbent, temperature alteration of the adsorbent can be prevented by using latent heat of the latent heat storage material in order to decrease the amount of fuel vapor remaining in the trap canister and to decrease the amount of fuel vapor passing through the trap canister. Furthermore, the first chamber is filled with the adsorbent and the latent heat storage material in the mixed manner, and the second chamber having the smaller cross-sectional area does not contain the latent beat storage material. Accordingly, it is able to prevent the adsorbent from mixing with the latent heat storage material in a non-uniform manner during assembly and use, so that it is able to keep stable adsorption and desorption ability. The second chamber has the smaller cross-sectional area, so that purge operation with the small amount of air can completely desorb fuel vapor from the adsorbent filled in the second chamber. Thus, it is not necessary to provide the latent heat storage material to the second chamber. Therefore, it is able to achieve both decrease in the amount of fuel vapor passing through the trap canister and decrease in pressure loss and to keep stable adsorption and desorption ability.

### BRIEF DESCRIPTION OF THE DRAWINGS

FIG. 1 is a cross-sectional view schematically showing a fuel vapor recovery system according to a first embodiment;

FIG. 2 is a cross-sectional view of a trap canister; and

FIG. 3 is a cross-sectional view of the trap canister according to a second Embodiment.

### DETAILED DESCRIPTION OF THE INVENTION

Each of the additional features and teachings disclosed above and below may be utilized separately or in conjunction with other features and teachings to provide improved trap canisters. Representative examples of the present invention, which examples utilized many of these additional features and teachings both separately and in conjunction with one another, will now be described in detail with reference to the attached drawings. This detailed description is merely intended to teach a person of skilled in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

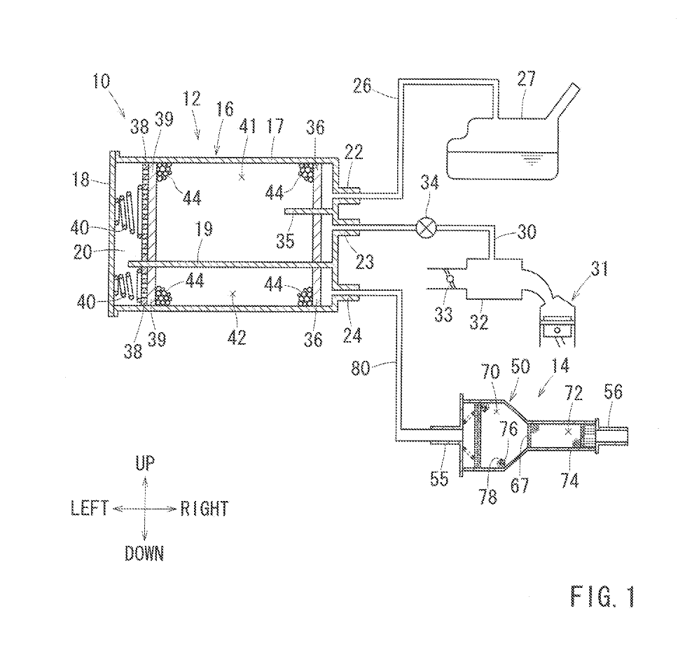

In a first embodiment, a fuel vapor recovery system to be mounted on a vehicle such as automobile will be described. FIG. 1 is a cross-sectional view showing the fuel vapor recovery system. For convenience of explanation, upper, lower, right and left directions are defined based on directions shown in FIG. 1. When the fuel vapor recovery system is mounted on a vehicle, actual directions of the fuel vapor recovery system may and may not correspond to the directions shown in FIG. 1. As shown in FIG. 1, a fuel vapor recovery system 10 has a main canister 12 and a trap canister 14. Here, the main canister 12 and the trap canister 14 will be described in sequence.

The main canister 12 will be described. The main canister 12 has a housing 16. The housing 16 is made from resin materials and is composed of a housing body 17 and a lid 18. The housing body 1 is formed in a hollow cuboidal shape that has an open end and a bottom end opposed to each other. The lid 18 is configured to close the open end of the housing body 17. In FIG. 1, the bottom end of the housing body 17 is positioned on a right side, and the lid 18 is positioned on a left side. An inner space of the housing body 17 is divided into an upper chamber and a lower chamber by a partition wall 19. A communication path 20 is defined in a space surrounded by me casing body 17 and the lid 18 such that the upper chamber and the lower chamber in the housing body 17 are communicated with each other via the communication path 20.

As shown in FIG 1, a tank port 22, a purge port 23 and a connection port 24 are formed at the right end of the housing body 17. The tank port 22 and the purge port 23 are communicated with the upper chamber, and that the connection port 24 is communicated with the lower chamber. The tank port 22 is connected to a fuel tank 27 (in particular, an upper section that retains gas) via a fuel vapor path 26. The purge port 23 is connected to an air intake path 32 of an internal combustion engine 31 via a purge path 30. The air intake path 32 is provided with a throttle valve 33 for controlling me amount of intake air. The purge path 30 is connected to the air intake path 32 (for example, at a surge tank) such that the connection point is downstream of the throttle valve 33. The purge path 30 is provided with a purge control valve 34 for opening and closing the purge path 30. While the engine 31 is running, an electronic control unit (ECU, not shown) controls the purge control valve 34 in order to carry out purge operation. The connection port 24 is connected to the trap canister 14 via a connection pipe 80 as described below.

A partition wall 35 divides a right end space in the upper chamber into an upper area and a lower area such that the upper area is communicated with the tank port 22 and the lower area is communicated with the purge port 23. The housing body 17 has filters 36 at its right end such that the filters 36 are disposed in the upper area, the lower area and the lower chamber, respectively. And, porous plates 38 are disposed at left ends of the upper and lower chambers, respectively. Filters 39 are disposed along and in contact with right surfaces of the porous plates 38, respectively. Spring members 40 (coil spring) are disposed, between the lid 18 and the porous plates 38, respectively. The spring members 40 bias the porous plates 38 toward a right direction. A space between the filters 36 and 39 in the upper chamber is called as first adsorption chamber 41. A space between the filters 36 and 39 in the lower chamber is called as second adsorption chamber 42. Each of the filters 36 and 39 is composed of, for example, non-woven fabric made from resin materials or foamed urethane.

The first adsorption chamber 41 and the second adsorption chamber 42 are filled with granular adsorbent 44 capable of adsorbing and desorbing fuel vapor such as butane. For example, the adsorbent 44 may be selected from granular activated carbon, crushed activated carbon and extruded activated carbon. The extruded activated carbon is formed by combining powdered (or crushed) activated carbon with a binder. In addition, the adsorbent 44 is composed of activated carbon having butane working capacity (BWC) below 13 g/dL, i.e., activated carbon having low adsorption capacity. Here, “butane working capacity (BWC)” is determined by ASTM D5228 standard test of ASTM international. And, adsorbent having BWC of 13 g/dL or higher is referred to as “adsorbent having high adsorption capacity”, while adsorbent having BWC below 13 g/dL is referred to as “adsorbent having low adsorption capacity”.

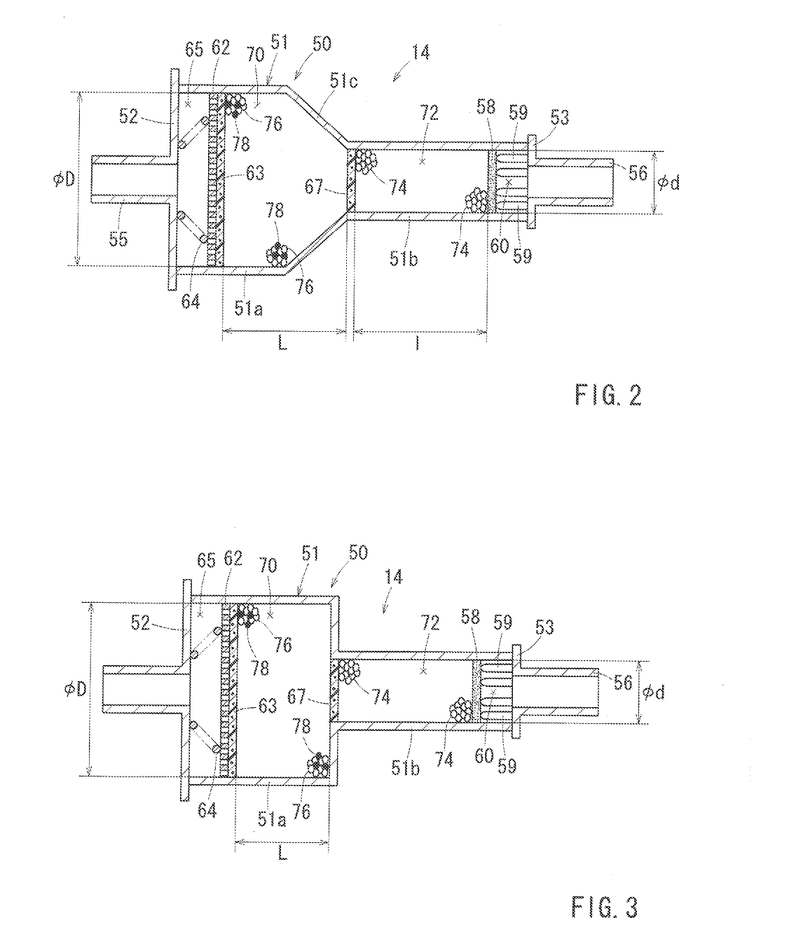

The trap canister 14 will be described. The trap canister 14 is separated from the main canister 12. FIG. 2 shows a cross-sectional view of the trap canister 14. As shown in FIG 2, the trap canister 14 has a housing 50. The housing 50 is made from resin materials and is composed of a housing body 51 and lids 52 and 53. The housing body 51 is formed in a hollow tube shape, and the lids 52 and 53 are configured to close both open ends of the housing body 51, respectively. The housing body 51 defines therein a path extending along its axial direction (horizontal direction). The housing body 51 concentrically has a large cylinder 51a on a left side and a small cylinder 51b on a right side. The large cylinder 51a has inner diameter φD. The small cylinder 51b has inner diameter φd. A tapered cylinder 51c is formed between the large cylinder 51a and the small cylinder 51b such that inner diameter of the tapered cylinder 51c gradually decreases toward the small cylinder 51b. The left lid 52 concentrically has a connection port 55 that is communicated with an inner space of the housing body 51. The right lid 53 concentrically has an air communicating port 56 that is communicated with the inner space of the housing body 51. The air communicating port 56 is open to the atmosphere. Although the large cylinder 51a, the small cylinder 51b, the tapered cylinder 51c, the connection port 55 and the air communicating port 56 are concentrically arranged in this embodiment, they may be disposed in a non-concentric manner.

A filter 58 is disposed near the right open end of the small cylinder 51b of the housing body 51. The filter 58 is made of, for example, non-woven fabric. The right lid 53 has a plurality of pin-shaped projections 59 protruding from a left surface of the right lid 53 in order to support the filter 58. Accordingly, a space 60 is defined between the right lid 53 and the filter 58. While, a porous plate 62 is disposed near the left open end of the large cylinder 51a of the housing body 51. A filter 63 is disposed along and in contact with a right surface of the porous plate 62. A spring member 64 (coil spring) is disposed between the porous plate 62 and the left lid 52. The spring member 64 biases the porous plate 62 toward the right direction. Thus, a space 65 is defined between the left lid 52 and the porous plate 62. The housing body 51 has an inner space between the filters 58 and 63, which functions as adsorption chamber (in detail, non-divided adsorption chamber).

A breathable partition member 67 is disposed at a left end of the small cylinder 51b of the housing body 51. The partition member 67 is composed of an elastic filter made from foamed resin such as foamed urethane. The partition member 67 divides the adsorption chamber into right and left chambers. The left chamber defined by the large cylinder 51b and the tapered cylinder 51c is called as large adsorption chamber 70, while the right chamber defined by the small cylinder 51b is called as small adsorption chamber 72.

The small adsorption chamber 72 is filled with granular adsorbent 74 capable of adsorbing and desorbing fuel vapor such as butane. The adsorbent 74 may be composed of, for example, granular activated carbon such as crushed activated carbon or extruded activated carbon formed by combining powdered (or crashed) activated carbon with a binder. The adsorbent 74 is composed of activated carbon having butane working capacity (BWC) of 13 g/dL or higher, i.e., activated carbon having high adsorption capacity. The filters 58 and 67 retain the adsorbent 74 in the small adsorption chamber 72 in order to prevent the adsorbent 74 from leaking from the small adsorption chamber 72.

Granular adsorbent 76 and heat storage material 78 are mixed and filled in the large adsorption chamber 70. The adsorbent 76 can adsorb and desorb fuel vapor such as butane and is composed of, for example, activated carbon having high adsorption capacity same with the adsorbent 74. The heat storage material 78 can prevent temperature alteration by using latent heat. The heat storage material 78 corresponds to latent heat storage material containing phase-change material releasing and absorbing latent heat depending on temperature alteration. Thus, the heat storage material 78 may be composed of, for example, phase-change material, microcapsule containing the phase-change material, or pellet containing each of the phase-change material and the microcapsule. Further, configuration of the heat storage material 78, such as shape and arrangement, can be freely determined. For example, it is able to use paraffin such as heptadecane melting at 22° C. and octadecane melting at 28° C. for the phase-change material. By using the heat storage material 78, it is able to prevent increase in temperature of the adsorbent 76 during adsorbing fuel vapor in order to facilitate fuel vapor adsorption, in addition, it is able to prevent decrease in temperature of the adsorbent 76 during describing fuel vapor in order to facilitate fuel vapor desorption. The filters 63 and 67 retain the adsorbent 76 and the heat storage material 78 in the large adsorption chamber 70 in order to prevent the adsorbent 76 and the heat storage material 78 from leaking from the large adsorption chamber 70.

Activated carbon having high adsorption capacity, which is used for the adsorbents 74 and 76, has higher BWC and smaller pore size than standard activated carbon (having low adsorption capacity), and thus creates stronger intermolecular force with remaining fuel vapor. Accordingly, the amount of fuel vapor diffusing can be decreased, so that the amount of the fuel vapor passing through the trap canister 14 can be decreased. BWC of the activated carbon used for the adsorbents 74 and 76 is preferably 15 g/dl, or higher, more preferably 17 g/dL or higher. Activated carbons used for the adsorbents 74 and 76 may be different from each other.

The large adsorption chamber 70 (in detail, the large cylinder 51a) has cross-sectional area (labeled with “A”) perpendicular to its axis. The small adsorption chamber 72 has cross-sectional area (labeled with “a”) perpendicular to its axis. The cross-sectional areas A and a are determined such that they meet relationship as “A>a”. Volume (labeled with “C”) of the large adsorption chamber 70 and volume (labeled with “c”) of the small adsorption chamber 72 are determined such that they meet relationship as “C>c”.

As shown in FIG 2, the large adsorption chamber 70 has path length L extending along its axial direction, i.e., flow direction of gas passing therethrough, and inner diameter D of the large cylinder 51a of the housing body 51 (i.e., diameter of a circle associated with the cross-sectional area A). The small adsorption chamber 72 has path length l extending along its axial direction, i.e., flow direction of gas passing therethrough, and inner diameter d of the small cylinder 51b of the housing body 51 (i.e., diameter of a circle associated with the cross-sectional area, a). The L/D ratio is lower than the l/d ratio. The tapered cylinder 51c of the housing body 51 gradually decreases cross-sectional area of the large adsorption chamber 70 toward the partition member 67. The L/D ratio is 1.1 or lower.

As shown in FIG 1, the connection port 55 of the trap canister 14 and the connection port 24 of the main canister 12 are connected with each other by the connection pipe 80. The large adsorption chamber 70 is also referred to as “adsorption chamber on the gas inlet side” herein. The small adsorption chamber 72 is also referred to as “adsorption chamber on the atmospheric side” herein. The connection pipe 80 is also referred to as “pipe” herein.

Next, operation of the fuel vapor recovery system 10 will be described. During refueling or normal condition (such as parking), fuel vapor containing gas, which contains fuel vapor vaporizes in the fuel tank 27, is introduced into the first adsorption chamber 41 via the tank port 22 of the main canister 12. The fuel vapor containing gas flows through the first adsorption chamber 41, the communication path 20 and the second adsorption chamber 42, in sequence. During this step, the fuel vapor contained in the fuel vapor containing gas is adsorbed onto the adsorbent 44 filled in the first adsorption chamber 41 and the second adsorption chamber 42. As a result, breakthrough gas is discharged from the main canister 12, and then is introduced into the trap canister 14 via the connection pipe 80. The breakthrough gas flows through the space 65, the large adsorption chamber 70 and the small adsorption chamber 72, in sequence. During this step, fuel vapor contained in the breakthrough gas is adsorbed onto the adsorbent 76 filled in the large adsorption chamber 70 and onto the adsorbent 74 filled in the small adsorption chamber 72. While the breakthrough gas flows through the trap canister 14, temperature increase of the adsorbent 76 during fuel vapor adsorption is prevented by using latent heat of the heat storage material 78 filled in the large adsorption chamber 70 in order to facilitate fuel vapor adsorption. Finally, air containing no or little fuel vapor is released to the atmosphere via the space 60 and the air communicating port 56.

During purge operation (purge control while the engine is running), the purge control valve 34 is opened depending on signals from the ECU. Then, negative pressure generated in the internal combustion engine 31 acts on the first adsorption chamber 41 via the purge port 23 of the main canister 12, so that atmospheric air flows through the trap canister 14 and the main canister 12 in an opposite direction to the flow direction of the fuel vapor containing gas (breakthrough gas). Accordingly fuel vapor is desorbed (purged) from the adsorbent 74 filled in the small adsorption chamber 72 and from the adsorbent 76 filled in the large adsorption chamber 70. During this step, the temperature decrease of the adsorbent 76 during fuel vapor desorption is prevented by using latent heat of the heat storage material 78 filled in the large adsorption chamber 70 in order to facilitate fuel vapor desorption. Subsequently, when air that contains fuel vapor flows through the second adsorption chamber 42 and the first adsorption chamber 41 of the main canister 12 toward the internal combustion engine 31, fuel vapor is desorbed from the adsorbent 44 filled in the first and second adsorption chambers 41 and 42 and then is introduced into the air intake path 32 of the internal combustion engine 31 via the purge port 23.

With respect to the trap canister 14 (FIG 2), the inner space of the housing 50 is divided by the breathable partition member 67 into the large adsorption chamber 70 and the small adsorption chamber 72 such that the cross-sectional area A of the large adsorption chamber 70 and the cross-sectional area a of the small adsorption chamber 72 meet relationship as “A>a”. Accordingly, it is able to improve adsorption and desorption ability of the adsorbent 74 in the small adsorption chamber 72 having the smaller cross-sectional area a. While, the large adsorption chamber 70 having the larger cross-sectional area A absorbs the pressure loss increase caused in the small adsorption chamber 72. Thus, it is able to prevent increase in the pressure loss, to decrease the amount of fuel vapor remaining in the trap canister 14, and to decrease the amount of fuel vapor passing through the trap canister 14.

The adsorbent 76 and the heat storage material 78 capable of preventing temperature alteration of the adsorbent 76 by using latent heat are mixed and filled in the large adsorption chamber 70. Since the temperature alteration of the adsorbent 76 is prevented by using latent heat of the heat storage material 78, it is able to decrease the amount of fuel vapor remaining in the large adsorption chamber 70 and to decrease the amount of fuel vapor passing through the trap canister 14.

The large adsorption chamber 70 contains the adsorbent 76 and the heat storage material 78 in a mixed manner, while the small adsorption chamber 72, which has the smaller cross-sectional area a, contains only adsorbent 74 without any heat storage material. Accordingly, it is able to prevent the adsorbent 76 from mixing with the heat storage material 78 in a non-uniform manner during assembly or use, so that it is able to keep stable adsorption and desorption ability. In addition, since the small adsorption chamber 72 has the smaller cross-sectional area a, the small amount of air can finish fuel vapor desorption from the adsorbent 74 filled in the small adsorption chamber 72 during the purge operation. Thus, it is not necessary to provide the heat storage material 78 to the small adsorption chamber 72.

Therefore, the trap canister 14 can achieve both decrease in fuel vapor passing therethrough and decrease in pressure loss and can keep stable adsorption and desorption ability.

Since it is not necessary to provide the heat storage material 78 to the small adsorption chamber 72, cost for the trap canister 14 can be decreased. And, the trap canister 14 does not need expensive honeycomb-shaped activated carbon, its cost can be decreased.

The large adsorption chamber 70 has the path length L and the inner diameter D associated with the cross-sectional area A. The small adsorption chamber 72 has the path length l and the inner diameter d associated with the cross-sectional area a. The L/D ratio is lower than the l/d ratio. Accordingly, adsorption and desorption ability of the adsorbent 74 in she small adsorption chamber 72 is improved. In addition, it is able to decrease the amount of fuel vapor remaining in the large adsorption chamber 70 and to decrease the amount of fuel vapor passing through the trap canister 14.

The cross-sectional area of the large adsorption chamber 70 gradually decreases toward the partition member 67. Accordingly, it is able to prevent pressure loss caused by drastic alteration of cross-sectional area.

The partition member 67 is composed of the elastic filter made from foamed resin. Accordingly, the partition member 67 can be simplified.

The adsorbent 76 in the large adsorption chamber 70 and the adsorbent 74 in the small adsorption chamber 72 have high adsorption capacity such that their BWCs are equal to or higher than 13 g/dL. Accordingly, it is able to ensure high adsorption capacity compared with a standard adsorbent having BWC between 8 and 12 g/dL.

A second embodiment will be described. Since this embodiment corresponds to the first embodiment with some changes, such changes will be described and the same configurations will not be described. FIG 3 is a cross-sectional view of the trap canister of this embodiment. As shown in FIG 3, the trap canister 14 has a straight-shaped large cylinder 51a instead of combination of the large cylinder 51a and the tapered cylinder 51c of the first embodiment (FIG. 2) such that the large cylinder 51a and the small cylinder 51b are arranged adjacent to each other. The large cylinder 51a has the same inner diameter D over its entire length, so that the large adsorption chamber 70 has the same cross-sectional area A over the path length L.

In other embodiments, at least the large adsorption chamber 70 of both adsorption chambers 70 and 72 may be filled with adsorbent having low adsorption capacity. The adsorption chambers 70 and 72 may have rectangular cross-section instead of round cross-section. The main canister 12 may have one or three adsorption chamber(s) instead of two adsorption chambers.

1. A trap canister for capturing fuel vapor contained in breakthrough gas discharged from an adsorbent canister, comprising:
a housing defining an adsorption chamber therein;
a breathable partition member disposed in the housing and dividing the adsorption chamber into a first chamber and a second chamber, the first chamber configured to receive breakthrough gas, the second chamber configured to communicate with the atmosphere; the first chamber having a cross-sectional area A larger than a cross-sectional area a of the second chamber;
an adsorbent filled in the first chamber and the second chamber; and
a latent heat storage material filled in the first chamber in a mixed manner with the Adsorbent.

2. The trap canister according to claim 1, wherein
the first chamber has path length L and diameter D associated with the cross-sectional area A, the second chamber has path length l and diameter d associated with the cross-sectional area a, and L/D is lower than l/d.

3. The trap canister according to claim 1, wherein
the first chamber is shaped such that cross-sectional area thereof gradually decreases toward the partition member.

4. The trap canister according to claim 1, wherein
the partition member is composed of an elastic filter made from foamed resin.

5. The trap canister according to claim 1, wherein
the adsorbent has butane working capacity of 13 g/dL or higher.

6. The trap canister according to claim 2, wherein
the adsorbent has butane working capacity of 13 g/dL or higher.
